(19) United States
(12) Patent Application Publication
(10) Pub. No.: US 2024/0354471 A1
(43) Pub. Date: Oct. 24, 2024

(54) APPARATUS AND METHOD FOR AUTOMATED GENERATION OF A MANUFACTURING ESTIMATE OF A COMPUTER MODEL

(71) Applicant: Paperless Parts, Inc., Boston, MA (US)

(72) Inventors: Scott M. Sawyer, Auburndale, MA (US); Darcy Parker, Boston, MA (US); Lucas M. Duros, Boston, MA (US); Jason Ray, Boston, MA (US)

(73) Assignee: Paperless Parts, Inc., Boston, MA (US)

(21) Appl. No.: 18/137,726

(22) Filed: Apr. 21, 2023

(51) Int. Cl. G06F 30/27

(52) U.S. Cl. CPC G06F 30/27; G06F 2119/18

(57) ABSTRACT

An apparatus for automated quoting of a computer model. The apparatus comprises at least a processor and a memory communicatively connected to the at least a processor. The memory instructs the at least a processor to receive a computer model comprises a plurality of model-based definitions, wherein the computer model is representative of the part to be manufactured. The memory then instructs the processor to determine manufacturability of the part to be manufactured as function of the plurality of model-based definitions and a plurality of manufacturing specifications, wherein the plurality of manufacturing specifications is generated using a domain specific language. The memory finally instructs the processor to generate a manufacturing estimate as a function of the manufacturability of the part to be manufactured, wherein the manufacturing estimate is generated using a manufacturing machine learning model.

### FIELD OF THE INVENTION

The present invention generally relates to the field of manufacturing estimates for the manufacture of a CAD model. In particular, the present invention is directed to an apparatus and method for automated generation of a manufacturing estimate of a computer model.

### BACKGROUND

Modern manufacturing processes pose a wide array of variables to account for in order to minimize cost and time. Sorting through the wide array of variables is time consuming in itself. As such, modern manufacturing processes are inefficient and can be improved.

### SUMMARY OF THE DISCLOSURE

In an aspect, an apparatus for automated quoting of a computer model. The apparatus includes at least a processor and a memory communicatively connected to the at least a processor. The memory containing instructions configuring the at least a processor to receive a computer model comprising a plurality of model-based definitions, wherein the computer model is representative of the part to be manufactured. The memory then instructs the processor to determine manufacturability of the part to be manufactured as function of the plurality of model-based definitions and a plurality of manufacturing specifications. The memory then instructs the processor to generate a manufacturing estimate as a function of the manufacturability of the part to be manufactured, wherein the manufacturing estimate is generated using an inference technique, such as a machine learning model, artificial intelligence model, or rules engine.

In another aspect, a method for automating quoting of a computer model. The method includes receiving, using at least a processor, a computer model, wherein the computer model comprising a plurality of model-based definitions, wherein the computer model is representative of a part to be manufactured. The method additionally includes encoding, using the at least a processor, a plurality of model-based definitions into the computer model. The method then includes determining, using the at least a processor, manufacturability of the part to be manufactured as function of the plurality of model-based definitions and a plurality of manufacturing specifications. The method additionally includes generating, using the at least a processor, a manufacturing estimate as a function of the manufacturability of the part to be manufactured, wherein the manufacturing estimate is generated using a manufacturing machine learning model.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment of an apparatus for automated quoting of a computer model;

FIG. 3 is a block diagram of an exemplary machine-learning process;

FIG. 4 is a block diagram of an exemplary embodiment of a manufacturability database;

FIG. 5 is a diagram of an exemplary embodiment of neural network;

FIG. 6 is a diagram of an exemplary embodiment of a node of a neural network;

FIG. 7 is a graph illustrating an exemplary relationship between fuzzy sets;

FIG. 8 is a flow diagram of an exemplary method for automated quoting of a computer model; and

FIG. 9 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for automated quoting of a computer model. The apparatus includes at least a processor and a memory communicatively connected to the at least a processor. The memory containing instructions configuring the at least a processor to receive a computer model comprising a plurality of model-based definitions, wherein the computer model is representative of the part to be manufactured. The memory then instructs the processor to determine manufacturability of the part to be manufactured as function of the plurality of model-based definitions and a plurality of manufacturing specifications. The memory then instructs the processor to generate a manufacturing estimate as a function of the manufacturability of the part to be manufactured, wherein the manufacturing estimate is generated using a manufacturing machine learning model. Exemplary embodiments illustrating aspects of the present disclosure are described below in the context of several specific examples.

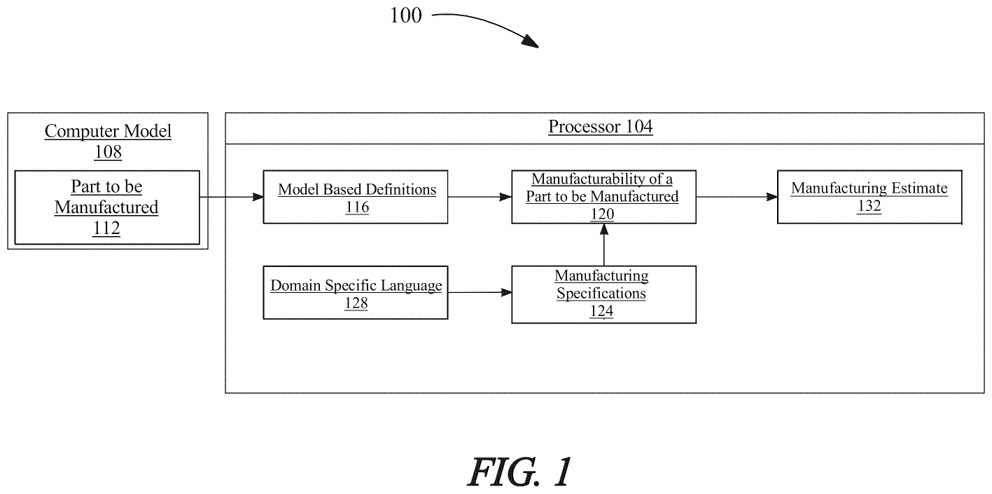

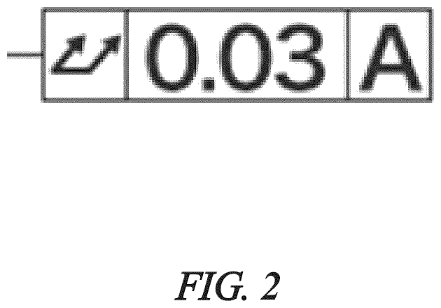

Referring now to FIG. 1, an exemplary embodiment of an apparatus 100 for automated quoting of a computer model. is illustrated. Apparatus 100 includes a processor 104. Processor 104 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Processor 104 may include a single computing device operating independently, or may include two or more computing device operating in concert, in parallel, sequentially or the like; two or more computing devices may be included together in a single computing device or in two or more computing devices. Processor 104 may interface or communicate with one or more additional devices as described below in further detail via a network interface device. Network interface device may be utilized for connecting processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus, or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 104 may include but is not limited to, for example, a computing device or cluster of computing devices in a first location and a second computing device or cluster of computing devices in a second location. Processor 104 may include one or more computing devices dedicated to data storage, security, distribution of traffic for load balancing, and the like. Processor 104 may distribute one or more computing tasks as described below across a plurality of computing devices of computing device, which may operate in parallel, in series, redundantly, or in any other manner used for distribution of tasks or memory between computing devices. Processor 104 may be implemented using a “shared nothing” architecture in which data is cached at the worker, in an embodiment, this may enable scalability of apparatus 100 and/or computing device.

With continued reference to FIG. 1, processor 104 may be designed and/or configured to perform any method, method step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, a memory is communicatively connected to the at least a processor 104. As used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Continuing to refer to FIG. 1, processor 104 is configured to receive a computer model 108 of a part for manufacture 112. Computer model 108 may include a plurality of sides. A “part for manufacture,” as used in this disclosure, is a part to be manufactured, wherein manufacturing may include any manufacturing process as described in the entirety of this disclosure. The part may include any item made of materials such as metals including, for example, aluminum and steel alloys, brass, and the like, plastics, such as nylon, acrylic, ABS, Delrin, polycarbonate, and the like, foam, composites, wood, etc. A “computer model,” as described herein, is a digital model of a physical structure created using computer-aided design (CAD) modeling software. Computer model 108 may include a three-dimensional image of part for manufacture 112. As used in this disclosure, a “three-dimensional image” is an image having, appearing to have, or displaying three dimensions, such as length, width, and height. For example and without limitation, computer-aided design (CAD) software may include SOLIDWORKS® software and/or CATIA software (available from Dassault Systèmes SolidWorks Corp, Waltham, Massachusetts), AUTOCAD® software and/or Fusion 360 software (available from Autodesk, Inc., San Rafael, California), PTC Creo software (available from PTC, Inc., Boston, Massachusetts), Siemens NX software (available from Siemens PLM Software, Plano, Texas) and MICROSTATION® software (available from Bentley Systems, Inc., Exton, Pennsylvania), and the like. Computer model 108 may further include any data describing and/or relating to a computer model of the part to be manufactured. Computer model 108 may include any modeling type, such as, without limitation, a wireframe, solid model, boundary representation, design intent that drives the previously described geometry (e.g., parameters, constraints and associative references to previous geometry and parameters), model parameters, Product Manufacturing Information (PMI), and/or any combination thereof. Computer model 108 may be saved in a computer file using any suitable file protocol, such as, without limitation, SolidWorks part file (.SLDPRT), several SolidWorks part files organized into a single assembly (.SLDASM), 3D assembly file supported by various mechanical design programs (.STP), graphics file saved in a 2D/3D vector format based on the Initial Graphics Exchange Specification (.IGS) and/or the like. Computer model 108 may further include information about the geometry and/or other defining properties of the structure of part for manufacture 112. Computer model 108 may include a polygon mesh, such as a collection of vertices, edges, and faces, which define the shape of computer model 108. For example and without limitation, the faces of the polygon mesh may include triangles, such as a triangle mesh, quadrilaterals, or other simple convex polygons.

Still referring to FIG. 1, computer model 108 may include a plurality of sides of part for manufacture 112. Each side of the plurality of sides, as used in this disclosure, may be a view of computer model 108 from a plane orthogonal to an axis passing through an origin of computer model 108. Views may also include various types of projections, auxiliary views, cross sections, and the like. The axis may include, as a non-limiting example, a three-axis coordinate system, such as the x-axis, y-axis, and z-axis, or abscissa, ordinate, and applicate. Persons skilled in the art, upon reviewing the entirety of this disclosure, will be aware of axes which may be suitable for use as each side of the plurality of sides consistently with this disclosure. The “origin” of the computer model, as described herein, is a fixed point of reference for computer model 108. For example and without limitation, the origin may include the center of mass, the geometric center, the center of a feature of the part, wherein a feature may be a hole, a well, a groove, a pocket, a channel, extruded volume, and the like. As a further example and without limitation, the origin may include any position of computer model 108.

Still referring to FIG. 1, a part for manufacture 112 may include a structure. A structure may include a building, other construction, residential property, commercial property, recreational property, gazebo, amphitheater, stadium, pergola, and the like. A structure may be similarly described by a computer model created using a CAD tool. The structure may contain model-based definitions that contain GD&T, material specifications, framing specifications, applicable codes, specifications of items to be used (such as doors, windows, and the like), dimensions, elevations, and the like.

Still referring to FIG. 1, the computer model 108 may include a plurality of model-based definitions 116. As used in the current disclosure, a “model-based definition” is a geometry and Product Manufacturing Information (PMI), which are annotations within the computer model 108 that is used to define an individual component or elements of the part for manufacture 112. Model-based definitions may further specify the modeled geometry or provide PMI that stipulates certain requirements on how an item must be manufactured. In some embodiments, a processor 104 may be configured to encode model-based definitions 116 onto the computer model. Encoding may include taking information that defines an individual component of the part for manufacture 112 and converting it in to form that may be display into computer model 108. Encoding may additionally include overlaying the defining information within the computer model 108. Defining an individual component or element may include information regarding geometric dimensioning and tolerancing (GD&T) information, component level materials, assembly level bills of materials, engineering configurations, surface finish, weld symbol, engineering history (including references to or embedded change orders and change notices), legal/proprietary notices, manufacturing processes, design intent, semantic data, material specifications, heat treatment specifications, ASTM specification, military specifications (MILSPEC), and the like. As used in the current disclosure, a “geometric dimensioning and tolerancing information” is information for defining and communicating engineering tolerances and relationships within a part for manufacturer 112. Geometric dimensioning and tolerancing information includes the degree of accuracy and precision is needed on each controlled feature of the component. GD&T may be used to define nominal (theoretically perfect) geometry of parts and assemblies, to define the allowable variation in form and possible size of individual features, and to define the allowable variation between features. Additionally, GD&T may describe the relationships between geometric features that each tolerance is based on. These relationships between tolerances may inform manufacturing setups and operations, and therefore provide a roadmap for estimation. Geometry may generally not be sufficient for determining how to manufacture an object because there may be many sequences of manufacturing setups and operations to achieve the nominal geometry described in the CAD model. GD&T may inform which subsets of these choices of manufacturing setups and operations are appropriate. Interpreting large quantities of GD&T in a model may be challenging either for a human combined with an algorithm or procedure. There are several standards available worldwide that describe the symbols and define the rules used in GD&T. One such standard is American Society of Mechanical Engineers (ASME) Y14.5. As used in the current disclosure, an “assembly level bill of materials” is a complete list of the components of a part to manufacture 112. An assembly level bill of materials may comprise all of the components required in an assembly. As used in the current disclosure, a “component material” is a material that a component is made of. For example, a component may be made of a plurality of metals and or plastics. Component Materials may additionally include the quality or quantity of the materials used for a given component. An individual component or element of a part for manufacture 112 may have a plurality of Model-Based Definitions 116. In a non-limiting example, a part for manufacture 112 may include a metal arm. Processor 104 may encode onto the metal arm a plurality of model-based definitions 116 that require the arm to have an architectural finish and designating the type of weld used to attach the metal arm to the rest of the part for manufacture 112. Model-based definitions 116 may be represented within the computer model 108 representing a part for manufacture 112. Model-based definitions 116 may be consistent with ASME standards, specifically ASME Y 14.41 In embodiments, Model-based definitions 116 may be visible to the user within the computer model 108 and readable by processor 104 and other manufacturing equipment. Model-based definitions 116 may be used to determine the manufacturability of the part to be manufactured 112. Model-based definitions 116 may also be used to generate a manufacturing estimate of the part to be manufactured 112. In some embodiments, model-based definitions 116 may be within the meta data of the computer model 108. Model-based definitions 116 may additionally be calculated by processor 104 and then encoded into computer model 108.

Still referring to FIG. 1, a plurality of model-based definitions 116 may include information regarding geometric dimensioning and tolerancing. A plurality of model-based definitions 116 may include geometric dimensions and tolerances such as geometric tolerance, 3D annotation and dimensions, PMI, PLM, and the like. As used in this disclosure, a “geometric tolerance” is a quantified limit of allowable error of one or more physical attributes of a part for manufacture. Model-based definitions 116 may include a form tolerance such as straightness, flatness, circularity, and/or cylindricity; a profile tolerance such as profile of a line and/or profile of a surface; an orientation tolerance such as angularity, perpendicularity, and/or parallelism; location tolerance such as position, concentricity and/or symmetry; a runout tolerance such as circular runout and/or total runout; and the like. Geometric dimensioning and tolerancing may be included in a computer model 108 of part for manufacture 112 as symbols, annotations, numerical values, text, embedded information, and/or the like. As used in this disclosure, “text” includes letters, numbers, and/or symbols.

Continuing to refer to FIG. 1, model-based definitions 116 may include semantic information of part for manufacture 112. “Semantic information,” as described in this disclosure, is data concerning and/or describing product and manufacturing information (PMI) and/or product life cycle management (PLM). PMI, as used in this disclosure, is data describing non-geometric attributes of a model of a part for manufacture, such as computer model 108, necessary for manufacturing the part, components of the part, and associated assemblies. For example and without limitation, PMI may include geometric dimensions and tolerances, 3D annotation and dimensions, surface finish, surface roughness, material specifications, and the like. PMI may include textual data, such as alphanumeric, punctuation, typographical symbols, character, string data, and/or any textual data as described in the entirety of this disclosure. PLM, as used in this disclosure, is any data concerning and/or describing management of the lifecycle of the part from inception, through engineering design and manufacture, to service and disposal of the manufactured part. PLM may include textual data, such as alphanumeric, punctuation, typographical symbols, character, string data, and/or any textual data as described in the entirety of this disclosure. In an embodiment, semantic information included in computer model 108 may be used in processes generating a manufacturing estimate for the part to be manufactured.

Still referring to FIG. 1, model-based definitions 116 may be represented on a print. A print may include an image representing part for manufacture 112 or a component of the part for manufacture 112, a number representing a numerical tolerance of the component, and/or an indicator that identifies the numerical tolerance is associated with the component. Print may also indicate a unit of measurement and/or a scale, which may be included in model-based definitions 116. For example, processor 104 may encode onto the computer model 108 or a print that the dimensions are in inches, and that the scale is “2:1”, include a circle representing an exterior cylindrical surface of part for manufacture 112, and have a leader (typically depicted as an arrow) pointing from “R0.5000+/−0.0003” to the circle. Processor 104 may be configured to insert “+/−” as a symbol representing a tolerance for the preceding number in the amount of the succeeding number. Processor 104 may also be configured to insert a leader pointing from the numbers to the circle, the tolerance for the circle is detailed by the numbers, specifically the radius of the circle. Processor 104 may be configured to identify the unit of measurement stated in print and determine that the radius tolerance for the circle is +/−0.0003 inches. In another non-limiting example, the leader may be pointing from a GD&T annotation of a total runout tolerance of 0.03 with respect to one or more features, as shown in FIG. 2.

With continued reference to FIG. 1, processor 104 is configured to encode a plurality of model-based definitions 116 on computer model 108. Encoding may include overlaying model-based definitions 116 with a computer model 108. Encoding may include positioning model-based definitions 116 in computer model 108 such that the model-based definitions 116 aligns with the component of part for manufacture 112 in the computer model 108. As used in this disclosure, a “component” of a part for manufacture is a feature, part, and/or piece of the part for manufacture. In a non-limiting example, encoding may include inserting model-based definitions 116 for a hole radius with a leader that was pointing to the hole in the computer model 108. Processor 104 may be configured to compare dimensions and/or coordinates of components of part for manufacture 112 in print and computer model 108 and associate the same components to model-based definitions 116 onto the computer model 108. Association may include matching one or more measurements and/or descriptions of a component in print with a component in computer model 108 including, without limitation, coordinates, height, length, width, radius, position on part for manufacture 112, and/or the like. In a non-limiting example, processor 104 may associate a circle in print to a cylinder in computer model 108 by comparing their corresponding radii, coordinates, and/or other measurements. As another non-limiting example, processor 104 may associate a circle designated by a position GD&T symbol assigned to a 0.5 diameter in print to the only cylinder with a 0.25 radius in computer model 108. As used in the current disclosure, a “print” may be a two-dimensional representation of a part for manufacture 112. A print may include any data describing the part for manufacture 112. Print may include semantic information of part for manufacture 112. Print may include geometric dimensioning and tolerancing (GD&T) information, which may be provided in one or more software files such as DXF files, DWG files, PDF files, and/or the like. Print may be received with computer model 108 of part for manufacture 112 or received in a separate transmission and/or from another source. Print may include a concentricity GD&T symbol assigned to a 0.75 inch hole in print, which processor 104 may associate with the only 0.375 inch radius hole in computer model 108. Once components of part for manufacture 112 in print are associated with their corresponding components of the part for manufacture 112 in computer model 108, then processor 104 may encode model-based definitions 116 on the computer model 108 while maintaining their relation to the corresponding measurements of the components. Similarly, processor 104 may associate a line in print with a surface of part for manufacture 112 in computer model 108 by, for example, comparing the length of the line with the length of the surface and/or comparing the positions of the line and surface on the corresponding images of part for manufacture 112 and/or in relational position to other components of the part for manufacture 112. As an additional example, encoding model-based definitions 116 on computer model 108 of the part for manufacture may further comprise associating a line of the print of the part for manufacture to a plane of the computer model 108 of the part for manufacture. In some embodiments, processor 104 model-based definitions 116 on computer model 108 may include encoding computer model 108, which may be a three-dimensional image of part for manufacture 112, onto print, which may include a two-dimensional image of the part for manufacture 112 and the original model-based definitions 116, such that the three-dimensional image is positioned on the two-dimensional image. As used in this disclosure, “encoding” is placing or laying an image or information over another image or information. For example, encoding a three-dimensional image of part for manufacture 112 onto print may include placing or laying the three-dimensional image of the part for manufacture 112 onto the image of the part for manufacture 112 in the print 116. Thus, the model-based definitions 116 on print may align with the corresponding components of computer model 108 of part for manufacture 112. In some embodiments, processor 104 may align an outer profile of a three-dimensional image of part for manufacture 112 in computer model 108 with an outer profile of a two-dimensional image of part for manufacture 112 in print.

With continued reference to FIG. 1, processor 104 may be configured to determine the manufacturability of the part to be manufactured 120 and as a function of the plurality of model-based definitions 116. As used in the current disclosure, “manufacturability” is the ease at which a product can be manufactured. In some embodiments, manufacturability may be determined with respect to model-based definitions 116 and/or manufacturing specifications 124. Manufacturability may be represented as a manufacturability score. A manufacturability score is discussed in greater detail herein below. In some embodiments, manufacturability may be determined with respect to a plurality of model-based definitions 116 including geometric dimensioning and tolerancing (GD&T), component level materials, assembly level bills of materials, engineering configurations, surface finish, manufacturing processes, design intent, semantic data, and the like. Manufacturability of a component may be determined as a function of the geometric tolerance to which the features must be made. For example, when he tighter the tolerance required, the lower manufacturability a product has. A feature annotated with GD&T may reference other datums that in turn reference other datums. This chain of ancestor relationships is referred to as GD&T “stack up.” The greater the stack up, the lower manufacturability the product has. In particular, high stack up downstream of a highly toleranced GD&T controls may result in harder to manufacture parts or features. Similarly, when a single GD&T annotation references multiple datums, this may also impact manufacturability. Additionally, the less restrictive tolerance requirements of the part for manufacture 112 are the more manufacturable it may become. Model-based definitions 116 may specify GD&T on a feature by feature basis. There may be creative ways to engineer components with lower tolerances that still perform as well as ones with higher tolerances. In other embodiments, manufacturability may be determined as a function of component level materials. The most manufacturable types of metals may generally include aluminum, brass, and softer metals. As materials get harder, denser, and stronger, such as steel, stainless steel, titanium, and exotic alloys, they may become much harder to machine and take much longer, thus being less manufacturable. Most types of plastic are easy to machine, although additions of fiberglass or carbon fiber can reduce the machinability. Plastics that are particularly soft and gummy may have machinability problems of their own.

With continued reference to FIG. 1, processor 104 may be configured to determine the manufacturability of the part to be manufactured 120 and as a function of a plurality of manufacturing specifications 124. As used in the current disclosure, “manufacturing specifications” are factors that affect the manufacturability of a part for manufacture. Examples of manufacturing specifications 124 may include, lead time, various expedited lead times, types of equipment needed, manufacturing operations to be performed, quantity, materials, material cost, oversized parts, undersized parts, attributes about the contact & account associated on the quote, Setup time, run time, hourly rate, quantity, part attributes, pricing options, crew size required for an operation, and the like. Manufacturing specifications 124 may be input by the manufacturer. As used in the current disclosure, “run time” is the time that is required for a component to be machined or manufactured. Run time may be calculated as a function of the size, processes, material, tools, and intricacies within computer model 108. As used it the current disclosure, “setup time” is the time that is required to prepare a part to be machined. Setup time may also include the time it takes to setup a machine or process to machine a part for manufacture. Set up time may be calculated as a function of the processes and machinery that is required to manufacture the component. Run time or setup time may be displayed in hourly increments. For example, run time may comprise ¾ of an hour per part on a CNC machine. Runtime and set-up may also be input by the manufacturer. Manufacturing specifications 124 may contain limitations of what a manufacturer can manufacture. This may include limitations on quantity, GD&T, types of materials, equipment available, various processes, lead time, and the like. In a non-limiting example, a given manufacturer may have manufacturing specifications 124 that make oversized parts extremely difficult to manufacture, thus the manufacturability of a given oversized part will be extremely high for this given manufacturer. In another non-limiting example, a given manufacturer may have manufacturing specifications 124 that may prevent them from producing a large quantity of parts on a short lead time. Thus, if a client requests 5000 parts on a lead time of four days, the manufacturability of this

With continued reference to FIG. 1, a plurality of manufacturing specifications 124 may be generated using a domain specific language 128. As used in the current disclosure, a “domain specific language” is a computer language specialized to a particular application domain. A domain specific language 128 may also be described as a computer language that is targeted to a particular kind of problem, rather than a general purpose language that is aimed at any kind of software problem. The domain specific language 128 of the current disclosure may be configured to allow a manufacturer to input the various factors that contribute to the manufacturability or pricing of a product. A domain specific language 128 may run at the operations level to estimate the cost and lead time required to perform that operation for a particular quantity. A programming language is a formal set of instructions that, when entered on a at least a processor 104, either directly or indirectly configure the processor 104 to perform one or more sequences of operations. A domain-specific language 128 may be used to provide the computing device with information to manufacture a part. A domain-specific language 128 may be configured to allow a user.

With continued reference to FIG. 1, a domain-specific language 128 (DSL) may include Paperless Parts Pricing Language (P3L). As used in the current disclosure, “Paperless Parts Pricing Language” is a domain specific language that is configured to allow a manufacturer to express various aspects to the manufacture of a product. Aspects may include cost, lead time, manufacturing operations, and manufacturing attributes, as well as the factors contributing to those attributes. Paperless Parts Pricing Language may allow a manufacturer to input a plurality of manufacturing specifications 124. In an embodiment, a Paperless Parts Pricing Language may be used to generate a manufacturing estimate or manufacturing quote as defined herein below. Each of the manufacturing specifications 124 may be used as an input when building a manufacturing estimate. In some embodiments, Paperless Parts Pricing Language may be based on a programing language such as Python. Paperless Parts Pricing Language extends Python by adding global objects and functions and removes some other Python functionality for security and performance. Paperless Parts Pricing Language may require little to no skill in software development to write or customize Paperless Parts Pricing Language. In some embodiments, Paperless Parts Pricing Language may be configured to be customized to allow a used to add different manufacturing specifications 124. The inputs to a Paperless Parts Pricing Language may include the computer model 108. Inputs may additionally include manufacturing specifications 124 including any shop or process-specific variables, like labor rate, machine rate, and so on.

With continued reference to FIG. 1, a plurality of manufacturing specifications 124 may be generated using a no code system. As used in the current disclosure, a “no code system” is a user interface allowing programming logic to be encoded by connecting blocks in different configurations. Blocks may represent different logical functions, such as if/else conditions, loops, transformations, aggregations, and the like. In another embodiment, manufacturing specifications may be generated using a rules engine. In a non-limiting example, a rules engine may enable the user to describe a plurality of situations or conditions and provide a plurality of manufacturing specifications to be applied as a result of that condition. The rules engine may contain a default set of rules widely applicable to manufacturing. The rules engine permits users to add their own rules or remove or edit the default or existing rules.

With continued reference to FIG. 1, processor 104 may be configured to determine the manufacturability of the part to be manufactured 120 and as a function of cost and time. In a non-limiting example of manufacturability of the part to be manufactured 120 as a function of cost and time, the manufacturability of the part may be determined as a function of the time required to not just machine (remove the material), but also the set-up time of the CNC machine or other machinery, NC programming, fixturing and many other activities that are dependent on the complexity and size of the part. The time and type of equipment required to produce the part to be manufactured 112 may directly correlate to the cost of the part to be manufactured 112.

With continued reference to FIG. 1, processor 104 may be configured to identify unmanufacturable qualities of the part. As used in the current disclosure, “unmanufacturable qualities” is any quality of the part to be manufactured 112 causes the part to be determined as unmanufacturable. In a non-limiting example, unmachinable qualities may include work material considerations, time, cost, the tools that are currently available, set-up and load time for the part to be manufactured, and the like. Processor 104 may be configured to cross-reference the model-based definitions 116 of the part to be manufactured 112 with the manufacturer specifications 124 to identify an unmanufacturable quality of the component. For example, a part to be manufactured 112 may include component that requires the manufacturer to machine the part out of metals that are notoriously difficult to work with, which may be reflected within the model-based definitions 116 for the part to be manufactured 112. Continuing with the example, the manufacturer specifications 124 may denote that the manufacturer cannot work with this particular metal thus making the component unmanufacturable. A processor 104 may also identify the time that it takes to set-up and machine the component and compare this to the cost to manufacture that component. If either the cost to make the component or the time it would take to make the component are unrealistic the component may be deemed unmanufacturable. The unmachinable qualities of the part may be displayed within the manufacturing quote or on the User device.

With continued reference to FIG. 1, processor 104 may be configured to identify corrections to the part to improve machinability. Corrections to the part may include suggestions to use a different material that is more machinable. In other embodiments, corrections may include suggesting a larger tolerance for a particular feature of the part for manufacture 112. Slight changes to the geometry of the features of the part may also be suggested to improve manufacturability. In embodiments, Processor 104 may be configured to output a plurality of different suggestions to improve machinability of the part for manufacture 112. In an embodiment, the corrections may be made as function of the identification of the unmanufacturable qualities of the component. For example, the processor 104 may have identified the component has a tight geometric tolerance which makes the component unmachinable. The processor 104 may identify geometric tolerance the manufacturer can offer as a function of the manufacturer specifications 124. Then the processor 104 may apply those tolerances to the component as correction to the part for manufacture 112, Part corrections may be displayed within the manufacturing quote.

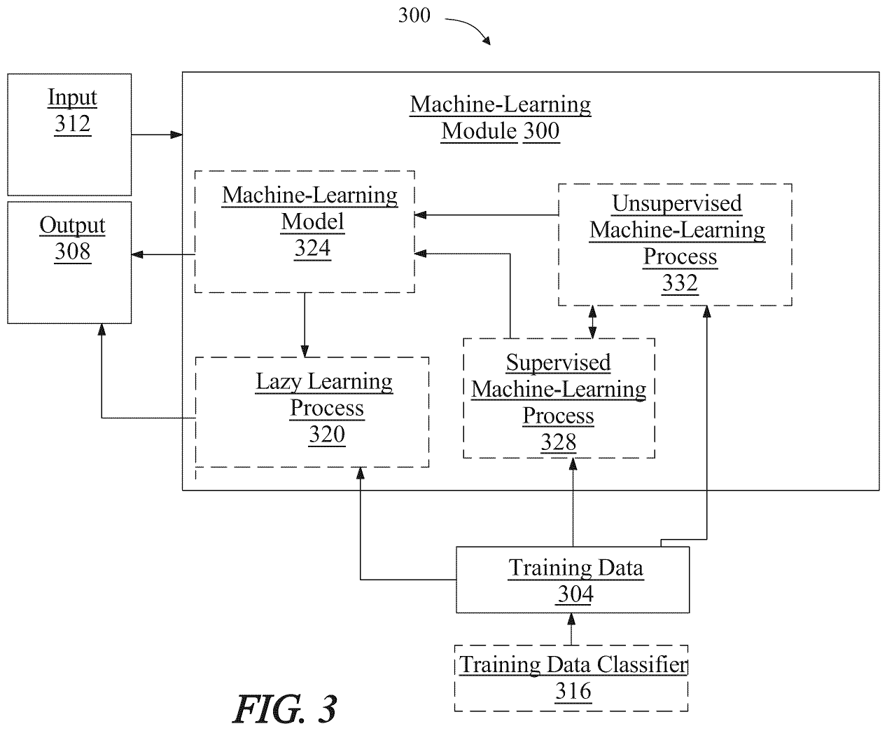

With continued reference to FIG. 1, processor 104 may determine manufacturability of the part to be manufactured 120 using a manufacturability machine learning model. As used in the current disclosure, a “manufacturability machine learning model” is a mathematical and/or algorithmic representation of a relationship between inputs and outputs. Manufacturability machine learning model may be similar to the machine learning model mentioned below in FIG. 3. In embodiments, a manufacturability machine learning model may include a classifier, which may be consistent with the classifier disclosed with reference to FIG. 3. Inputs to the to the manufacturability machine learning model may include model-based definitions 116, manufacturing specifications 124, examples of manufacturability of a part for manufacturer 112, examples of a manufacturability score, and the like. The output of the manufacturability machine learning model may include a prediction of the manufacturability of a part for manufacturer 112 and a manufacturability score. Manufacturability machine learning model may by trained using manufacturability training data. Manufacturability training data is a plurality of data entries containing a plurality of inputs that are correlated to a plurality of outputs for training a processor 104 by a machine-learning process. Manufacturability training data may be configured to correlate model-based definitions 116 and manufacturing specifications 124 as an input to the manufacturability of a part for manufacturer 112. Manufacturability training data may be configured to correlate a model-based definitions 116 and manufacturing specifications 124 as an input to the identification of a unmachinable qualities of the component as an output. Manufacturability training data may additionally be configured to correlate a model-based definitions 116 and manufacturing specifications 124 as an input to cost and the time to manufacture them as an output. Manufacturability training data may include model-based definitions 116, manufacturing specifications 124, examples of manufacturability of a part for manufacturer 112, examples of a manufacturability score, and the like. Examples of manufacturability of a part for manufacturer 112 and examples of a manufacturability score may include any manufacturability score or manufacturability of a part for manufacturer that was generated prior to the current prediction of manufacturability of a part for manufacturer. Manufacturability training data may be stored in a database, such as a training data database, or remote data storage device, or a user input or device. In an embodiment, a manufacturability training data may be iteratively updated with the input and output results of the manufacturability machine learning model. Updated manufacturability training data may then be used to retrain manufacturability machine learning model using a feedback loop.

Still referring to FIG. 1, a processor may be configured to generate a machine learning model, such as manufacturability machine learning model, using a Naïve Bayes classification algorithm. Naïve Bayes classification algorithm generates classifiers by assigning class labels to problem instances, represented as vectors of element values. Class labels are drawn from a finite set. The Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A)P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Processor 104 may then calculate a likelihood table by calculating probabilities of different data entries and classification labels. Processor 104 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

Still referring to FIG. 1, processor may be configured to generate a machine learning model, such as manufacturability machine learning model, using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 1, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm: I=\sqrt{Σᵢ₌₀ⁿαᵢ²}, where ai is attribute number experience of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With continued reference to FIG. 1, a machine learning model, such as manufacturability machine learning model, may be implemented as a fuzzy inferencing system. As used in the current disclosure, a “fuzzy inference” is a method that interprets the values in the input vector (i.e. manufacturing specifications 124 and model-based definitions 116.) and, based on a set of rules, assigns values to the output vector. A fuzzy set may also be used to show degree of match between fuzzy sets may be used to rank one resource against another. For instance, if both manufacturing specifications 124 and model-based definitions 116 have fuzzy sets, the manufacturability of the part to be manufactured 120 may be identified by having a degree of overlap exceeding a predetermined threshold.

With continued reference to FIG. 1, GD&T annotations may be topologically sorted, creating a graph of GD&T relationships. There may be multiple graph representations that accurately capture the relationships between annotations. These solutions inform the candidate manufacturing setup and operation sequences. These graphs may be clustered or partitioned. Clustering and partitioning of the GD&T relationships helps organize the GD&T into smaller chunks that are more easily digested by humans and software that automates analyzing the GD&T. Clustering or partitioning helps with divide and conquer strategies when working with large sets of GD&T. Clustering or partitioning also helps identify features that are highly coupled relationships and will require extra care to control when manufacturing those features.

Still referring to FIG. 1, processor 104 may be configured to display the manufacturability of a product as manufacturability score. As used in the current disclosure, a “manufacturability score” is a rating of the manufacturability of a component of a part for manufacture 112. A manufacturability score may be calculated on a numerical scale, for instance a scale from 1-10. In a non-limiting example, a score of 1 may be an easily manufactured component of a part for manufacture 112, whereas a rating of 10 may be extremely difficult to manufacture. A manufacturability score may score each component of the part to be manufactured 112.

Manufacturability score may be generated by comparing the manufacturing specifications 124 and model-based definitions 116 of the component of the part to be manufactured 112. In a non-limiting example, the model-based definitions 116 may identify a component needing a highly specialized finishing process and manufacturing specifications 124 may identify that the manufacturer specializes in the aforementioned finishing process, however it requires a six week lead time. Processor 104 may compare the manufacturing specifications 124 and model-based definitions 116 to produce a manufacturability score of 8 out of 10. In some embodiments, a manufacturability score may be generated as a using a machine learning model such as manufacturability machine learning model. In these embodiments, manufacturability training data may include as outputs manufacturability scores. In some embodiments, generating the manufacturability score may include linear regression techniques. Processor 104 may be designed and configured to create a machine-learning model using techniques for development of linear regression models. Linear regression models may include ordinary least squares regression, which aims to minimize the square of the difference between predicted outcomes and actual outcomes according to an appropriate norm for measuring such a difference (e.g., a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm mounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g., a quadratic, cubic or higher-order equation) providing a best predicted output/actual output fit is sought; similar methods to those described above may be applied to minimize error functions, as will be apparent to persons skilled in the art upon reviewing the entirety of this disclosure.

With continued reference to FIG. 1, processor 104 may be configured to generate a manufacturing quote as a function of the manufacturability of the part to be manufactured 112. As used in the current disclosure, a “manufacturing quote” is a report detailing the dimensions of the part and the manufacturability of the part to be manufactured. A manufacturing quote may also include the geometrical tolerances to go with each feature of the part and the ability of the manufacturer to deliver those geometrical tolerances. A manufacturing quote may include a recommendation of which work materials to use to manufacture the part out of. In some embodiments, a manufacturing quote may include suggested methods of assembly for the part. A manufacturing quote may also include suggestions on the most efficient order of assembly for the part. Manufacturing quotes may also denote that the part is unable to be manufactured due to issues regarding manufacturing specifications 124 and model-based definitions 116. Additionally, a manufacturing quote may make suggestions on corrections to an unmachinable part in order to make it manufacturable. These suggestions may include increasing the tolerances for various features, or changing the material of the part, using other machining tools. In an embodiment, a manufacturing quote may be generated using a domain specific language.

With continued reference to FIG. 1, processor 104 may be configured to generate a manufacturing estimate 132 as a function of the manufacturability of the part to be manufactured 112. As used in the current disclosure, a “manufacturing estimate” is a report detailing the amount the manufacturer will charge to manufacture a component. A manufacturing estimate 132 may additionally contain information regarding the lead time required to deliver a component of a part. A manufacturing estimate 132 may provide suggestions to make a component more affordable or more manufacturable. A manufacturing estimate 132 may output cost as a function of lead time, manufacturing specifications 124, model-based definitions 116. A quantity curve can be produced by the running within a manufacturing estimate 132, wherein the quantity curve identifies the price and lead time per part as a function of the quantity of the part ordered. This can then be shown graphically. In embodiments, the manufacturing estimate 132 may be calculated as a function of setup time, hourly rate, run time, and/or quantity made. In an embodiment, processor 104 may be configured to assign an hourly rate to each of the setup time, man hours, and run time. Processor 104 may multiply the setup time, man hours, and run time by the hourly rate. That is then added to the cost of materials and other shop costs. The summation of all of these values is the manufacturing estimate 132. Processor 104 may produce manufacturing estimate 132 on a quantity curve. Thus, the manufacturing estimate 132 may fluctuate as function of the quantity of a part that is ordered. Manufacturing estimate 132 may be itemized for client convenience. In an embodiment, a manufacturing estimate 132 may be generated using a domain specific language.

With continued reference to FIG. 1, a processor 104 may generate a manufacturing estimate 132 using a using a lookup table. A “lookup table,” for the purposes of this disclosure, is an array of data that maps input values to output values. A lookup table may be used to replace a runtime computation with an array indexing operation. In another non limiting example, a manufacturing look up table may be able to correlate setup time, man hours, and run time to an hourly rate. Processor 104 may be configured to “lookup” one or more setup time, man hours, and run time, hourly rates, time, manufacturing specifications 124, model-based definitions 116, and the like, in order to generate a manufacturing estimate 132.

With continued reference to FIG. 1, processor 104 is configured to generate a manufacturing estimate 132 using a manufacturing machine learning model. As used in the current disclosure, a “manufacturing machine learning model” is a mathematical and/or algorithmic representation of a relationship between inputs and outputs. Manufacturing machine learning model may be similar to the machine learning model mentioned herein below in FIG. 3. In embodiments, a manufacturing machine learning model may include a classifier, which may be consistent with the classifier disclosed with reference to FIG. 3. Inputs to the to the manufacturing machine learning model may include model-based definitions 116, manufacturing specifications 124, the manufacturability of a part for manufacturer 112, a manufacturability score, examples of a manufacturing estimate 132, and the like. The output of the manufacturing machine learning model may include a manufacturing estimate 132. Manufacturing machine learning model may be trained using manufacturing training data. Manufacturing training data is a plurality of data entries containing a plurality of inputs that are correlated to a plurality of outputs for training a processor 104 by a machine-learning process. Manufacturing training data may be configured to correlate manufacturability of a part for manufacturer 112 as an input to a manufacturing estimate 132 as an output. Manufacturing training data may include model-based definitions 116, manufacturing specifications 124, manufacturability of a part for manufacturer 112, manufacturability score, examples of a manufacturing estimate, and the like. Examples of a manufacturing estimate may include any manufacturing estimate 132 that was generated prior to the current manufacturing estimate 132. Manufacturing training data may be stored in a database, such as a training data database, or remote data storage device, or a user input or device. In some embodiment, examples of manufacturing estimates may be received from manufacturability database 300.

Referring now to FIG. 3, an exemplary embodiment of a machine-learning module 300 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 304 to generate an algorithm that will be performed by a computing device/module to produce outputs 308 given data provided as inputs 312; this is in contrast to a non-machine learning software program where the commands to be executed are determined in advance by a user and written in a programming language.

Still referring to FIG. 3, “training data,” as used herein, is data containing correlations that a machine-learning process may use to model relationships between two or more categories of data elements. For instance, and without limitation, training data 304 may include a plurality of data entries, each entry representing a set of data elements that were recorded, received, and/or generated together; data elements may be correlated by shared existence in a given data entry, by proximity in a given data entry, or the like. Multiple data entries in training data 304 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 304 according to various correlations; correlations may indicate causative and/or predictive links between categories of data elements, which may be modeled as relationships such as mathematical relationships by machine-learning processes as described in further detail below. Training data 304 may be formatted and/or organized by categories of data elements, for instance by associating data elements with one or more descriptors corresponding to categories of data elements. As a non-limiting example, training data 304 may include data entered in standardized forms by persons or processes, such that entry of a given data element in a given field in a form may be mapped to one or more descriptors of categories. Elements in training data 304 may be linked to descriptors of categories by tags, tokens, or other data elements; for instance, and without limitation, training data 304 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively, or additionally, and continuing to refer to FIG. 3, training data 304 may include one or more elements that are not categorized; that is, training data 304 may not be formatted or contain descriptors for some elements of data. Machine-learning algorithms and/or other processes may sort training data 304 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 304 to be made applicable for two or more distinct machine-learning algorithms as described in further detail below. Training data 304 used by machine-learning module 300 may correlate any input data as described in this disclosure to any output data as described in this disclosure.

Further referring to FIG. 3, training data may be filtered, sorted, and/or selected using one or more supervised and/or unsupervised machine-learning processes and/or models as described in further detail below; such models may include without limitation a training data classifier 316. Training data classifier 316 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 300 may generate a classifier using a classification algorithm, defined as a processes whereby a computing device and/or any module and/or component operating thereon derives a classifier from training data 304. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Still referring to FIG. 3, machine-learning module 300 may be configured to perform a lazy-learning process 320 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 304. Heuristic may include selecting some number of highest-ranking associations and/or training data 304 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 3, machine-learning processes as described in this disclosure may be used to generate machine-learning models 324. A “machine-learning model,” as used in this disclosure, is a mathematical and/or algorithmic representation of a relationship between inputs and outputs, as generated using any machine-learning process including without limitation any process as described above and stored in memory; an input is submitted to a machine-learning model 324 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 324 may be generated by creating an artificial neural network, such as a convolutional neural network comprising an input layer of nodes, one or more intermediate layers, and an output layer of nodes. Connections between nodes may be created via the process of “training” the network, in which elements from a training data 304 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 3, machine-learning algorithms may include at least a supervised machine-learning process 328. At least a supervised machine-learning process 328, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include a manufacturing specifications 124 and model-based definitions 116 as inputs, autonomous functions as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 304. Persons skilled in the art, upon reviewing the entirety of this disclosure, will be aware of various possible variations of at least a supervised machine-learning process 328 that may be used to determine relation between inputs and outputs. Supervised machine-learning processes may include classification algorithms as defined above.

Further referring to FIG. 3, machine learning processes may include at least an unsupervised machine-learning processes 332. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 3, machine-learning module 300 may be designed and configured to create a machine-learning model 324 using techniques for development of linear regression models. Linear regression models may include ordinary least squares regression, which aims to minimize the square of the difference between predicted outcomes and actual outcomes according to an appropriate norm for measuring such a difference (e.g., a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g., a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 3, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

For example, and still referring to FIG. 3, neural network also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes, one or more intermediate layers, and an output layer of nodes. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 3, a node may include, without limitation, a plurality of inputs x/that may receive numerical values from inputs to a neural network containing the node and/or from other nodes. Node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above. In an embodiment, and without limitation, a neural network may receive semantic units as inputs and output vectors representing such semantic units according to weights wᵢ that are derived using machine-learning processes as described in this disclosure.

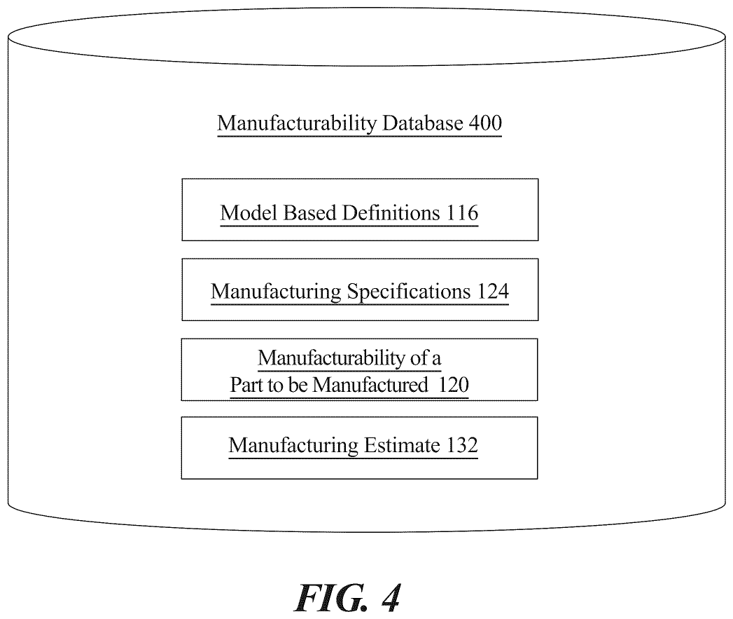

Now referring to FIG. 4, an exemplary manufacturability database 400 is illustrated by way of block diagram. In an embodiment, model-based definitions 116, manufacturing specifications 124, manufacturability of the part to be manufactured 120, a manufacturability score, a manufacturing estimate 132, and the like may be stored in a manufacturability database 400 (also referred to as “database”). Processor 104 may be communicatively connected with manufacturability database 400. For example, in some cases, database 400 may be local to processor 104. Alternatively or additionally, in some cases, database 400 may be remote to processor 104 and communicative with processor 104 by way of one or more networks. Network may include, but not limited to, a cloud network, a mesh network, or the like. By way of example, a “cloud-based” system, as that term is used herein, can refer to a system which includes software and/or data which is stored, managed, and/or processed on a network of remote servers hosted in the “cloud,” e.g., via the Internet, rather than on local severs or personal computers. A “mesh network” as used in this disclosure is a local network topology in which the infrastructure processor 104 connects directly, dynamically, and non-hierarchically to as many other computing devices as possible. A “network topology” as used in this disclosure is an arrangement of elements of a communication network. Manufacturability database 400 may be implemented, without limitation, as a relational database, a key-value retrieval database such as a NOSQL database, or any other format or structure for use as a database that a person skilled in the art would recognize as suitable upon review of the entirety of this disclosure. Manufacturability database 400 may alternatively or additionally be implemented using a distributed data storage protocol and/or data structure, such as a distributed hash table or the like. Manufacturability database 400 may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

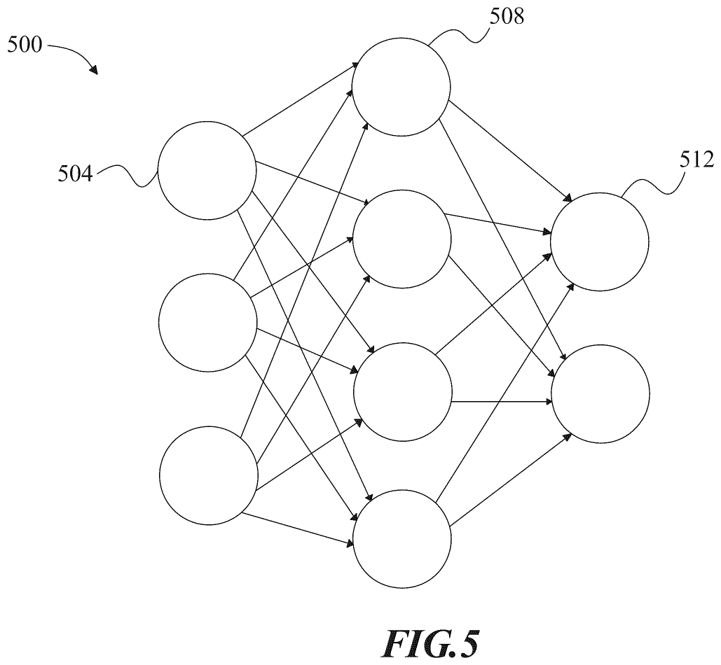

Referring now to FIG. 5, an exemplary embodiment of neural network 500 is illustrated. A neural network 500, also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 504, one or more intermediate layers 508, and an output layer of nodes 512. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

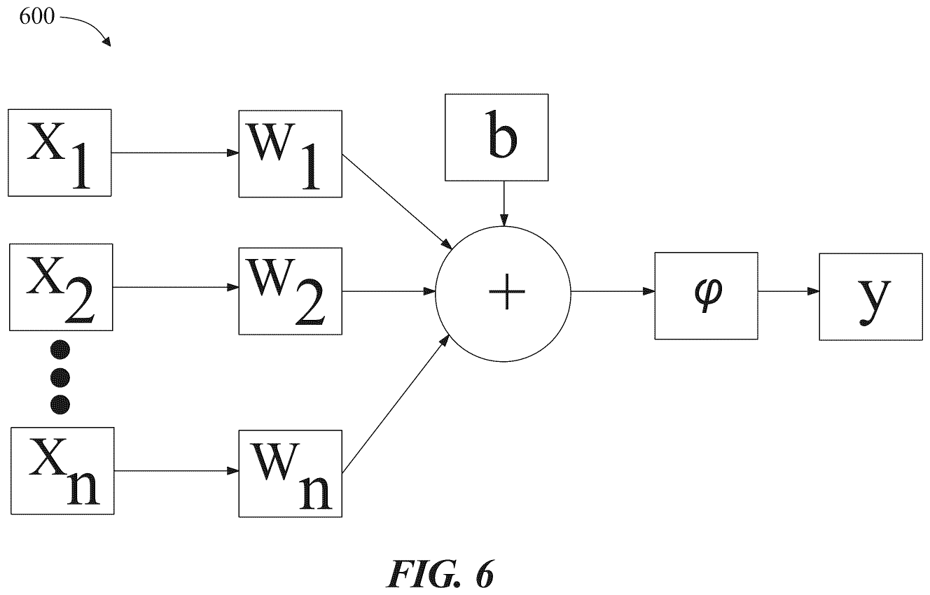

Referring now to FIG. 6, an exemplary embodiment of a node of a neural network is illustrated. A node may include, without limitation, a plurality of inputs xᵢ that may receive numerical values from inputs to a neural network containing the node and/or from other nodes. Node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

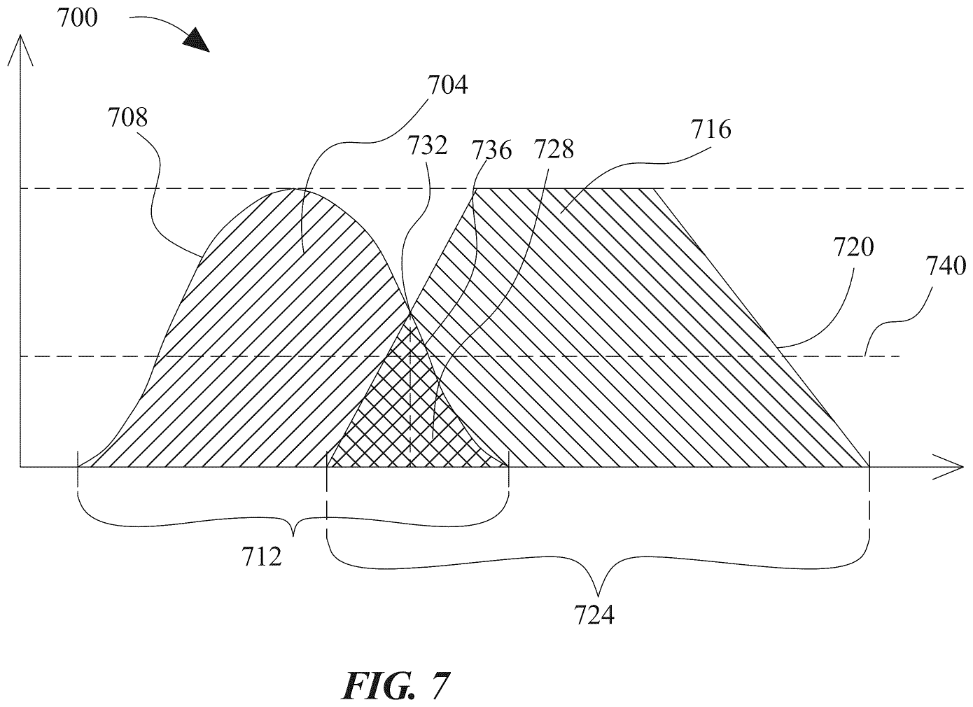

Now referring to FIG. 7, an exemplary embodiment of fuzzy set comparison 700 is illustrated. In a non-limiting embodiment, the fuzzy set comparison. In a non-limiting embodiment, fuzzy set comparison 700 may be consistent with fuzzy set comparison in FIG. 1. In another non-limiting the fuzzy set comparison 700 may be consistent with the name/version matching as described herein. For example and without limitation, the parameters, weights, and/or coefficients of the membership functions may be tuned using any machine-learning methods for the name/version matching as described herein. In another non-limiting embodiment, the fuzzy set may represent user manufacturability of the part for manufacture 112, manufacturing specifications 124, and model-based definitions 116 from FIG. 1.

Still referring to FIG. 7, inference engine may be implemented according to input and/or output manufacturing specifications 124, model-based definitions 116, manufacturability of the part for manufacture 112. For instance, an acceptance variable may represent a first measurable value pertaining to the classification of a manufacturing specifications 124 to a model-based definitions 116. Continuing the example, an output variable may represent the manufacturability of the part for manufacture 112. In an embodiment, manufacturing specifications 124 and model-based definitions 116 may be represented by their own fuzzy set. In other embodiments, the manufacturability of the part for manufacture 112 may be represented as a function of the intersection two fuzzy sets as shown in FIG. 7, An inference engine may combine rules, such as any semantic versioning, semantic language, version ranges, and the like thereof. The degree to which a given input function membership matches a given rule may be determined by a triangular norm or “T-norm” of the rule or output function with the input function, such as min (a, b), product of a and b, drastic product of a and b, Hamacher product of a and b, or the like, satisfying the rules of commutativity (T (a, b)=T(b, a)), monotonicity: (T (a, b)≤ T(c, d) if a≤ c and b≤d), (associativity: T(a, T (b, c))=T(T (a, b), c)), and the requirement that the number 1 acts as an identity element. Combinations of rules (“and” or “or” combination of rule membership determinations) may be performed using any T-conorm, as represented by an inverted T symbol or “⊥,” such as max (a, b), probabilistic sum of a and b (a+b-a*b), bounded sum, and/or drastic T-conorm; any T-conorm may be used that satisfies the properties of commutativity: ⊥(a, b)=⊥(b, a), monotonicity: ⊥(a, b)≤⊥(c, d) if a≤ c and b≤d, associativity: ⊥(a, ⊥(b, c))=⊥(⊥(a, b), c), and identity element of 0. Alternatively or additionally T-conorm may be approximated by sum, as in a “product-sum” inference engine in which T-norm is product and T-conorm is sum. A final output score or other fuzzy inference output may be determined from an output membership function as described above using any suitable defuzzification process, including without limitation Mean of Max defuzzification, Centroid of Area/Center of Gravity defuzzification, Center Average defuzzification, Bisector of Area defuzzification, or the like. Alternatively or additionally, output rules may be replaced with functions according to the Takagi-Sugeno-King (TSK) fuzzy model.

A first fuzzy set 704 may be represented, without limitation, according to a first membership function 708 representing a probability that an input falling on a first range of values 712 is a member of the first fuzzy set 704, where the first membership function 708 has values on a range of probabilities such as without limitation the interval [0,1], and an area beneath the first membership function 708 may represent a set of values within first fuzzy set 704. Although first range of values 712 is illustrated for clarity in this exemplary depiction as a range on a single number line or axis, first range of values 712 may be defined on two or more dimensions, representing, for instance, a Cartesian product between a plurality of ranges, curves, axes, spaces, dimensions, or the like. First membership function 708 may include any suitable function mapping first range 712 to a probability interval, including without limitation a triangular function defined by two linear elements such as line segments or planes that intersect at or below the top of the probability interval. As a non-limiting example, triangular membership function may be defined as:

$$y ( x , a , b , c ) = \{ \begin{matrix}0 , for x > c and x < a \\ \frac{x - a}{b - a} , for a \leq x < b \\ \frac{c - x}{c - b} , if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c , ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

First fuzzy set 704 may represent any value or combination of values as described above, including any software component datum, any source repository datum, any malicious quantifier datum, any predictive threshold datum, any string distance datum, any resource datum, any niche datum, and/or any combination of the above. A second fuzzy set 716, which may represent any value which may be represented by first fuzzy set 704, may be defined by a second membership function 720 on a second range 724; second range 724 may be identical and/or overlap with first range 712 and/or may be combined with first range via Cartesian product or the like to generate a mapping permitting evaluation overlap of first fuzzy set 704 and second fuzzy set 716. Where first fuzzy set 704 and second fuzzy set 716 have a region 736 that overlaps, first membership function 708 and second membership function 720 may intersect at a point 732 representing a probability, as defined on probability interval, of a match between first fuzzy set 704 and second fuzzy set 716. Alternatively or additionally, a single value of first and/or second fuzzy set may be located at a locus 736 on first range 712 and/or second range 724, where a probability of membership may be taken by evaluation of first membership function 708 and/or second membership function 720 at that range point. A probability at 728 and/or 732 may be compared to a threshold 740 to determine whether a positive match is indicated. Threshold 740 may, in a non-limiting example, represent a degree of match between first fuzzy set 704 and second fuzzy set 716, and/or single values therein with each other or with either set, which is sufficient for purposes of the matching process; for instance, the manufacturability of the part for manufacture 112 may indicate a sufficient degree of overlap with manufacturing specifications 124 and model-based definitions 116 for combination to occur as described above. Each threshold may be established by one or more user inputs. Alternatively or additionally, each threshold may be tuned by a machine-learning and/or statistical process, for instance and without limitation as described in further detail below.

In an embodiment, a degree of match between fuzzy sets may be used to rank one resource against another. For instance, if both manufacturing specifications 124 and model-based definitions 116 have fuzzy sets, manufacturing specifications 124 and model-based definitions 116 may be matched to the manufacturability of the part for manufacture 112 by having a degree of overlap exceeding a predictive threshold, processor 104 may further rank the two resources by ranking a resource having a higher degree of match more highly than a resource having a lower degree of match. Where multiple fuzzy matches are performed, degrees of match for each respective fuzzy set may be computed and aggregated through, for instance, addition, averaging, or the like, to determine an overall degree of match, which may be used to rank resources; selection between two or more matching resources may be performed by selection of a highest-ranking resource, and/or multiple notifications may be presented to a user in order of ranking.

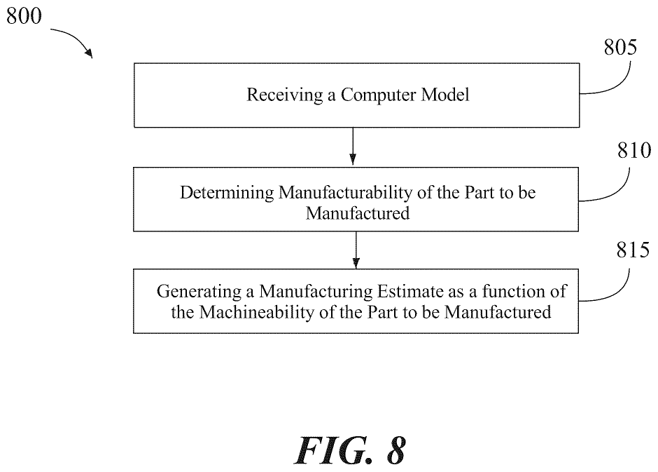

Referring to FIG. 8, an exemplary method 800 for automating quoting of a computer model. Method 800 includes a step 805, of receiving, using at least a processor, a computer model, wherein the computer model comprises a plurality of model based definitions, wherein the computer model is representative of the part to be manufactured. This may occur as described above in reference to FIGS. 1-6. In some embodiments, the plurality of model-based definitions may include at least geometric, dimensioning, and tolerancing, an assembly level bill of materials, and/or component materials.

With continued reference to FIG. 8, method 800 includes a step 810 of determining, using the at least a processor, manufacturability of the part to be manufactured 120 as function of the plurality of model-based definitions and a plurality of manufacturing specifications. This may occur as described above in reference to FIGS. 1-6. In an embodiment, the method further may further comprise determining, using the at least a processor, the manufacturability of the part to be manufactured as function of cost and time. The method further may further comprise determining, using the at least a processor, the unmanufacturable qualities of the part to be manufactured. The method further may further comprise generating the plurality of manufacturing specifications using a domain specific language.

In other embodiments, the plurality of manufacturing specifications may include at least a run-time. The method may further comprise generating, using the at least a processor, a manufacturability score as a function of manufacturability of the part to be manufactured. The manufacturability of the part to be manufactured 120 may be determined using a manufacturability machine learning model. The manufacturability of the part to be manufactured 120 may also be determined as a function of a fuzzy set.

With continued reference to FIG. 8, method 800 includes a step 815 of generating, using the at least a processor, a manufacturing estimate as a function of the manufacturability of the part to be manufactured, wherein the manufacturing estimate is generated using a manufacturing machine learning model. This may occur as described above in reference to FIGS. 1-6.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

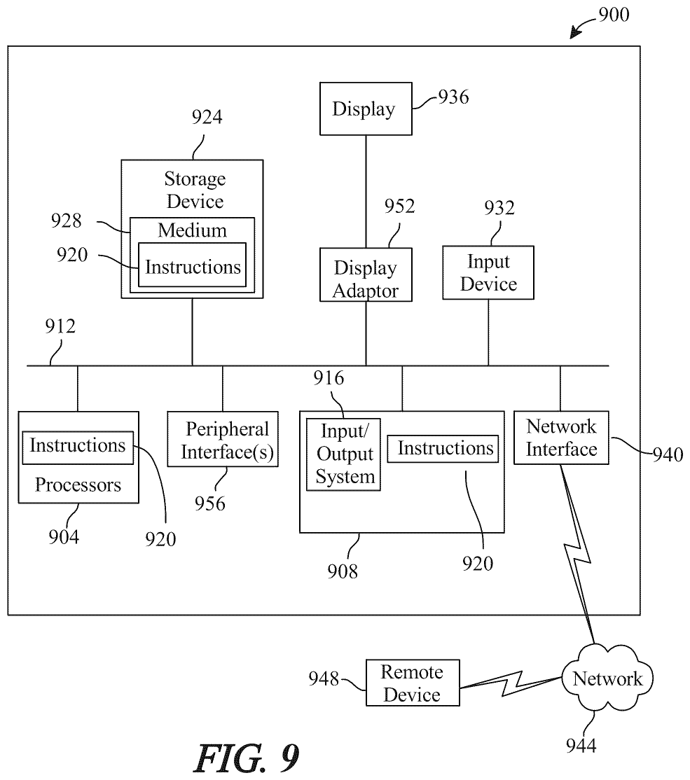

FIG. 9 shows a diagrammatic representation of one embodiment of a computing device in the exemplary form of a computer system 900 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 900 includes a processor 904 and a memory 908 that communicate with each other, and with other components, via a bus 912. Bus 912 may include any of several types of bus structures including, but not limited to, a memory bus, a memory controller, a peripheral bus, a local bus, and any combinations thereof, using any of a variety of bus architectures.

Processor 904 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 904 may be organized according to Von Neumann and/or Harvard architecture as a non-limiting example. Processor 904 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 908 may include various components (e.g., machine-readable media) including, but not limited to, a random-access memory component, a read only component, and any combinations thereof. In one example, a basic input/output system 916 (BIOS), including basic routines that help to transfer information between elements within computer system 900, such as during start-up, may be stored in memory 908. Memory 908 may also include (e.g., stored on one or more machine-readable media) instructions (e.g., software) 920 embodying any one or more of the aspects and/or methodologies of the present disclosure. In another example, memory 908 may further include any number of program modules including, but not limited to, an operating system, one or more application programs, other program modules, program data, and any combinations thereof.

Computer system 900 may also include a storage device 924. Examples of a storage device (e.g., storage device 924) include, but are not limited to, a hard disk drive, a magnetic disk drive, an optical disc drive in combination with an optical medium, a solid-state memory device, and any combinations thereof. Storage device 924 may be connected to bus 912 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 924 (or one or more components thereof) may be removably interfaced with computer system 900 (e.g., via an external port connector (not shown)). Particularly, storage device 924 and an associated machine-readable medium 928 may provide nonvolatile and/or volatile storage of machine-readable instructions, data structures, program modules, and/or other data for computer system 900. In one example, software 920 may reside, completely or partially, within machine-readable medium 928. In another example, software 920 may reside, completely or partially, within processor 904.

Computer system 900 may also include an input device 932. In one example, a user of computer system 900 may enter commands and/or other information into computer system 900 via input device 932. Examples of an input device 932 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 932 may be interfaced to bus 912 via any of a variety of interfaces (not shown) including, but not limited to, a serial interface, a parallel interface, a game port, a USB interface, a FIREWIRE interface, a direct interface to bus 912, and any combinations thereof. Input device 932 may include a touch screen interface that may be a part of or separate from display 936, discussed further below. Input device 932 may be utilized as a user selection device for selecting one or more graphical representations in a graphical interface as described above.

A user may also input commands and/or other information to computer system 900 via storage device 924 (e.g., a removable disk drive, a flash drive, etc.) and/or network interface device 940. A network interface device, such as network interface device 940, may be utilized for connecting computer system 900 to one or more of a variety of networks, such as network 944, and one or more remote devices 948 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus, or other relatively small geographic space), a telephone network, a data network associated with a telephone/voice provider (e.g., a mobile communications provider data and/or voice network), a direct connection between two computing devices, and any combinations thereof. A network, such as network 944, may employ a wired and/or a wireless mode of communication. In general, any network topology may be used. Information (e.g., data, software 920, etc.) may be communicated to and/or from computer system 900 via network interface device 940.

Computer system 900 may further include a video display adapter 952 for communicating a displayable image to a display device, such as display device 936. Examples of a display device include, but are not limited to, a liquid crystal display (LCD), a cathode ray tube (CRT), a plasma display, a light emitting diode (LED) display, and any combinations thereof. Display adapter 952 and display device 936 may be utilized in combination with processor 904 to provide graphical representations of aspects of the present disclosure. In addition to a display device, computer system 900 may include one or more other peripheral output devices including, but not limited to, an audio speaker, a printer, and any combinations thereof. Such peripheral output devices may be connected to bus 912 via a peripheral interface 956. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

What is claimed is:

1. An apparatus for automated generation of a manufacturing estimate of a computer model, wherein the apparatus comprises:
at least a processor; and
a memory communicatively connected to the at least a processor, the memory containing instructions configuring the at least a processor to:
receive a computer model comprising a plurality of model-based definitions, wherein the computer model is representative of a part to be manufactured;
determine a manufacturability of the part to be manufactured as function of the plurality of model-based definitions and a plurality of manufacturing specifications; and
generate a manufacturing estimate as a function of the manufacturability of the part to be manufactured, wherein the manufacturing estimate is generated using a manufacturing machine learning model.

2. The apparatus of claim 1, wherein the memory contains additional instructions configuring the processor to determine the manufacturability of the part to be manufactured as function of a cost and a time.

3. The apparatus of claim 1, wherein the memory contains additional instructions configuring the processor to determine unmanufacturable qualities of the part to be manufactured.

4. The apparatus of claim 1, wherein the plurality of model-based definitions comprises at least geometric dimensioning and tolerancing information.

5. The apparatus of claim 1, wherein the plurality of model-based definitions comprises at least an assembly level bill of materials.

6. The apparatus of claim 1, wherein the plurality of model-based definitions comprises at least component materials.

7. The apparatus of claim 1, wherein the plurality of manufacturing specifications comprises at least a run time.

8. The apparatus of claim 1, wherein the memory further contains instructions configuring the processor to generate a manufacturability score as a function of manufacturability of the part to be manufactured.

9. The apparatus of claim 1, wherein the memory further contains instructions configuring the processor to encode the plurality of model-based definitions into the computer model.

10. The apparatus of claim 1, wherein the plurality of manufacturing specifications are generated using a domain specific language.

11. A method for automating quoting of a computer model, wherein the method comprises
receiving, using at least a processor, a computer model comprising a plurality of model-based definitions, wherein the computer model is representative of a part to be manufactured;
determining, using the at least a processor, manufacturability of the part to be manufactured as function of the plurality of model-based definitions and a plurality of manufacturing specifications;
generating, using the at least a processor, a manufacturing estimate as a function of the manufacturability of the part to be manufactured, wherein the manufacturing estimate is generated using a manufacturing machine learning model.

12. The method of claim 11, wherein method further comprises determining, using the at least a processor, the manufacturability of the part to be manufactured as function of a cost and a time.

13. The method of claim 11, wherein method further comprises determining, using the at least a processor, unmanufacturable qualities of the part to be manufactured.

14. The method of claim 11, wherein the plurality of model-based definitions comprises at least geometric, dimensioning, and tolerancing information.

15. The method of claim 11, wherein the plurality of model-based definitions comprises at least an assembly level bill of materials.

16. The method of claim 11, wherein the plurality of model-based definitions comprises at least component materials.

17. The method of claim 11, wherein the plurality of manufacturing specifications comprises at least a run-time.

18. The method of claim 11, wherein method further comprises generating, using the at least a processor, a manufacturability score as a function of manufacturability of the part to be manufactured.

19. The method of claim 11, wherein method further comprises encoding, using the at least a processor, the plurality of model-based definitions into the computer model.

20. The method of claim 11, wherein the plurality of manufacturing specifications is generated using a domain specific language.
